(19) United States
(12) Patent Application Publication
(10) Pub. No.: US 2008/0114603 A1
(43) Pub. Date: May 15, 2008

(54) CONFIRMATION SYSTEM FOR COMMAND OR SPEECH RECOGNITION USING ACTIVATION MEANS

(75) Inventor: Daniel Desrochers, Quebec (CA)

Correspondence Address: BROOKS KUSHMAN P.C., 1000 TOWN CENTER, TWENTY-SECOND FLOOR, SOUTHFIELD, MI, 48075, US

(73) Assignee: Adacel, Inc., Broussard, QC (CA)

(21) Appl. No.: 11/559,921

(22) Filed: Nov. 15, 2006

(51) Int. Cl. G10L 15/00

(52) U.S. Cl. 704/275; 704/E15.001

(57) ABSTRACT

A system and method for confirming command or speech recognition results returned by an automatic speech recognition (ASR) engine from a command issued by an operator of a vehicle or platform, such as an aircraft or unmanned air-vehicle (UAV). The operator transmits a command signal to the ASR engine, initiated by an activation means, such as a push-button (formally known as push-to-talk or push-to-recognize). A recognition result is communicated to the user and the system awaits the confirmation for a limited period of time. During this period, in one embodiment, a low tone with high prosody is played to notify the user that the system is ready to receive the confirmation. If the user quickly presses and releases the push-button a predetermined number of times (for instance, twice to make a double-click), the result is confirmed and the ASR forwards a command signal to a system controlled thereby. Otherwise, the ASR waits for another speech command.

### BACKGROUND OF THE INVENTION

1. Field of the Invention

This invention relates to automatic command or speech recognition (collectively herein “ASR”) and more particularly to a system for and method of confirmation by a recognition result returned by the ASR of a signal, such as a speech command issued by a user.

2. Background Art

Speech recognition is the process of converting a speech signal to a set of words. Speech recognition applications have appeared in various areas, including call routing, data entry and simulation for training purposes. The technology that built existing automatic speech recognition engines has also evolved. Over the last years, several have tried to find ways to improve speech recognition accuracy. While some approaches focus on noise robustness, statistical language, natural language post-processing, there are still unresolved problems. For example, uncertainty to knowing an automatic command or speech recognition (ASR) engine failing to match the command and/or returns a wrong recognition result.

Today, the best-commercialized ASR engines reach a high-level of 98-99% word accuracy: unfortunately the impact of one error might be critical in some applications, especially for a false positive error.

To use speech recognition for operational purposes, especially for life-critical applications (like an in-vehicle or a platform such as a car, aircraft, helicopter, or boat), there is a need to provide the user a speech recognition interface with a level of accuracy that reaches safety levels of 99.9999%, in other words—virtually failsafe speech recognition conditions. Since no existing commercialized speech recognition engines can guarantee 100% of sentence accuracy, the user must be able to validate the recognized speech command and discard wrong results before passing the command to the system.

In speech recognition applications where environmental noise occurs most of the time, out of control and possibly considerable, the ASR is usually driven by an activation means, such as a push-button (sometimes known as push-to-recognize PTR or push-to-talk PTT speech recognition model). This technique performs better because the user specifies to the ASR where and when to start and stop analysis of the signal. With this manual end-pointing speech recognition model, the ASR does not need to process abrupt environment noise or user speech when the user speaks to other persons. The user typically presses and holds the button while he speaks his command and releases it afterwards, like using a walkie-talkie in radio communication. The ASR only recognizes the speech signal provided between the button press and release. It then retrieves the meaning of the command and returns the corresponding results.

In some cases, the application that hosts the ASR also includes a Text-To-Speech (TTS) engine and, in combination or not with visual feedback, will output audio or aural feedback. This feedback might take multiple forms—noticeably a simple read back of the recognition result or a request to confirm the result. For instance, with speech command like “set heading 320”, an application might read back “heading 320” or request for confirmation like, “confirm heading 320.” In typical voice user interface systems with such feedback, the application will wait for confirmation of the recognition result before triggering the appropriate command.

Some confirmation techniques use implicit commands to confirm the last speech recognition result. These types of techniques are discussed in U.S. Pat. No. 5,930,751, entitled “METHOD OF IMPLICIT CONFIRMATION FOR AUTOMATIC SPEECH RECOGNITION”, which is incorporated herein by reference. One problem with the concept of a speech command to confirm a speech command is that the confirmation might not be recognized by the user. Or even worse, the speech recognition by the ASR of the confirmation command from the user can potentially be recognized by the ASR as false positive when the user was saying something else. The user might also find himself in a situation where he gets good recognition of his command but is unable to effectively confirm it.

### SUMMARY OF THE INVENTION

Accordingly, there is a need for an automatic command or speech recognition (collectively “ASR”)-user interface that gives the user a way to confirm a recognition result with very high reliability. Instead of giving a speech command to confirm the last recognition result, one aspect of the invention uses an activation means, such as a push-button, that starts and stops the ASR processing, but in a different manner from prior approaches to confirm the result.

When the user provides his command to the ASR, the signal that composes the speech command is delimited manually with the push-button. The ASR performs command recognition on the utterance and produces the recognition results. From that moment, a timer is started. In some embodiments of the invention, the result is displayed to the user with a question mark: e.g., “heading 320?”. A low tone, typically with a high prosody (raising intonation) is played to the user to get his attention and indicates that a recognition result needs to be confirmed. The user quickly presses and releases the push-button a predetermined number of times (for instance, twice) to indicate to the application that the result was correct. Upon the user's confirmation, if in a timely fashion, the application triggers appropriate commands to a system that is controlled by the ASR.

In some embodiments of the invention, if a false-positive error occurs during recognition by the ASR of the command from the user, the user can discern and notice the error. The user then simply presses the button again and repeats his command to the ASR to receive another speech recognition result from the ASR and therefore receive another request for confirmation from the ASR. If a confirmation appears when no result to be confirmed was pending, the event is simply ignored.

### BRIEF DESCRIPTION OF THE DRAWINGS

FIG. 1 is a process flow diagram illustrating a confirmation system for speech recognition results using an activation means; and

FIG. 2 is an illustrative timing diagram of system stimuli and responses.

### DETAILED DESCRIPTION OF THE PREFERRED EMBODIMENT(S)

One aspect of the invention relates to a system and method for confirming command recognition results returned by an automatic command recognition (ASR) engine from a command (e.g. an utterance) issued by an operator of vehicle or platform.

As a non-limiting example, consider the following scenario: a user/operator/pilot (“pilot”) is in command of a vehicle/equipment/platform/aircraft or unmanned air or ground-based vehicle with an automatic heading control system that under carefully defined circumstances will respond to acceptable commands or signals communicated by the pilot. An example of one such command (“stimulus”) may be: “turn left to a 320 degree heading.” Coupled with the heading control system is an automatic speech recognition (ASR) engine. The ASR will receive the command (signal) communicated by the pilot, respond to him/her (“response”) and process the signal in a manner to be described later. Only after several processing conditions are met will the signal/command be acted upon by the heading control system (the “controlled system”).

Other examples of environments in which several aspects of the disclosed confirmation system in combination with a controlled system may be used include, at least in the aeronautical environment, altitude change (e.g., “descend to 5,000 feet”); lowering the landing gear (e.g., “gear down”); activate illumination systems (e.g., “landing lights on”); flap/speed brake control (e.g., “flaps 10 degrees”); speed changes (e.g., “approach speed 120 knots”); sink rate (e.g., “descend at 500 feet per minute”) and other such applications which illustrate how many aspects of the disclosed system may usefully be deployed.

Against the background of these examples, the main stimuli and responses may be considered at a higher level to more generally occur in this sequence:

| | | Controlled |
|---|---|---|
| User | ASR | System |
| | Signal | |
| 1 | → | |
| | (Speech command) | |
| | Recognition result | |
| 2 | ← | |
| | (Recognized speech command) | |
| | Validate | |
| 3 | → | |
| | (Confirm recognition result) | |
| 4 | | → |
| | | command |

It will be understood that the ASR-activation means may be deployed in many different environments, such as in—but not limited to—aircraft, helicopters, UAVs, boats, automobiles and other moving platforms or machines. Other environments may include lunar or other planetary excursion or transportation modules, tanks, unmanned and manned aeronautical and ground-based vehicles, weapon deployment systems and the like. It will also be appreciated that the disclosed invention may usefully be deployed in non-critical environments such as voice dialing applications in cell phones and PDA's.

In a more general sense, several aspects of the invention can usefully be deployed in environments which lack a keyboard or a mouse or a touch screen.

It will be appreciated that the illustrative examples used in this disclosure are not to be construed in a limiting manner.

As mentioned earlier, the disclosed system in one embodiment has explicit controls (“activation means”) that initiate command recognition. It is therefore more robust in an operational environment where ambient noise is out of control, and possibly considerable. One benefit of the system is that it provides better accuracy and therefore reliability than known prior art solutions.

The system described in this invention is preferably implemented with a speaker-dependent or -independent ASR engine that supports discrete or continuous recognition. The presented voice user interface (VUI) works with the condition that an activation means, such as a push-button (e.g., PTR) is available to the user. As used herein, the term “activation means” includes all means used by a user/pilot/operator to initiate and send a signal to the ASR. Such means include, but are not limited to, a spoken command, a push-to-talk (PTT) signal that may emanate from a microphone, a signal emitted by a keypad that is available to the pilot/user/operator, a button, a foot pedal, an on/off switch, a vasculating switch, eye movement, a tactile means for generating a signal (such as one activated by squeezing), and comparable wireless and wired activation means. In a preferred embodiment, the user issues a speech command to the ASR engine while pressing and holding the push-button and releases the button almost immediately after the speech command ends. In some environments, it may be desirable to employ the same activation means by which the user may not only send a signal to the ASR initially, but also to confirm what the ASR recognizes.

One embodiment of a speech recognition engine includes the DynaSpeak from Stanford Research Institute (SRI), of Menlo Park, Calif. Another is the Automatic Speech Recognition (ASR) or Open Speech Recognizer (OSR) sold by Nuance Corp of Burlington, Mass. 01803. Such speech recognition systems may operate on a general-purpose microprocessor (such as a Pentium or PowerPC processor) under the control of such operating systems as Microsoft Windows, or Linux, or a real-time operating system.

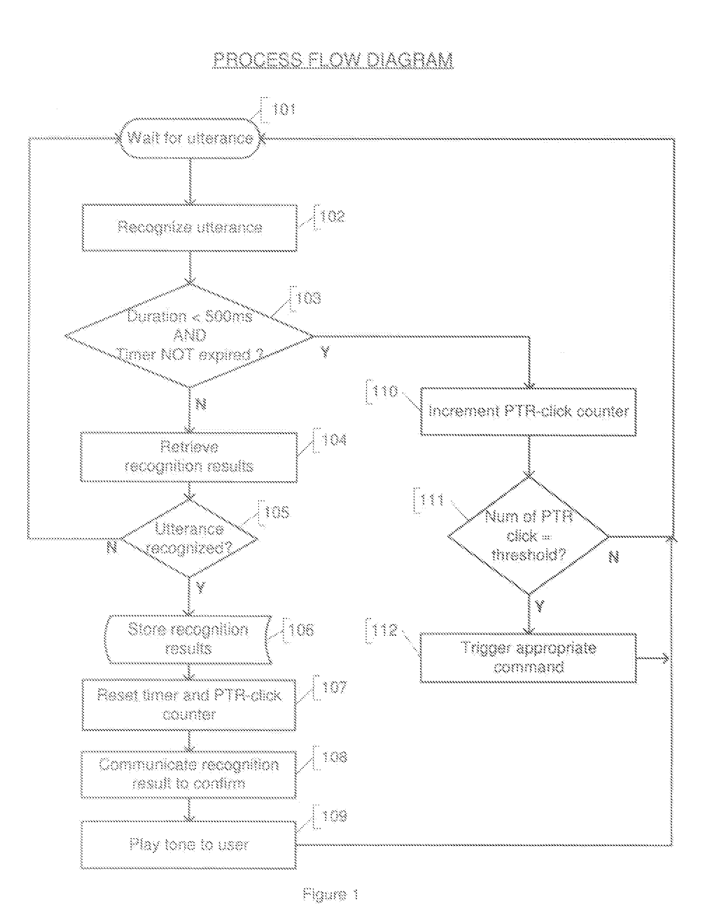

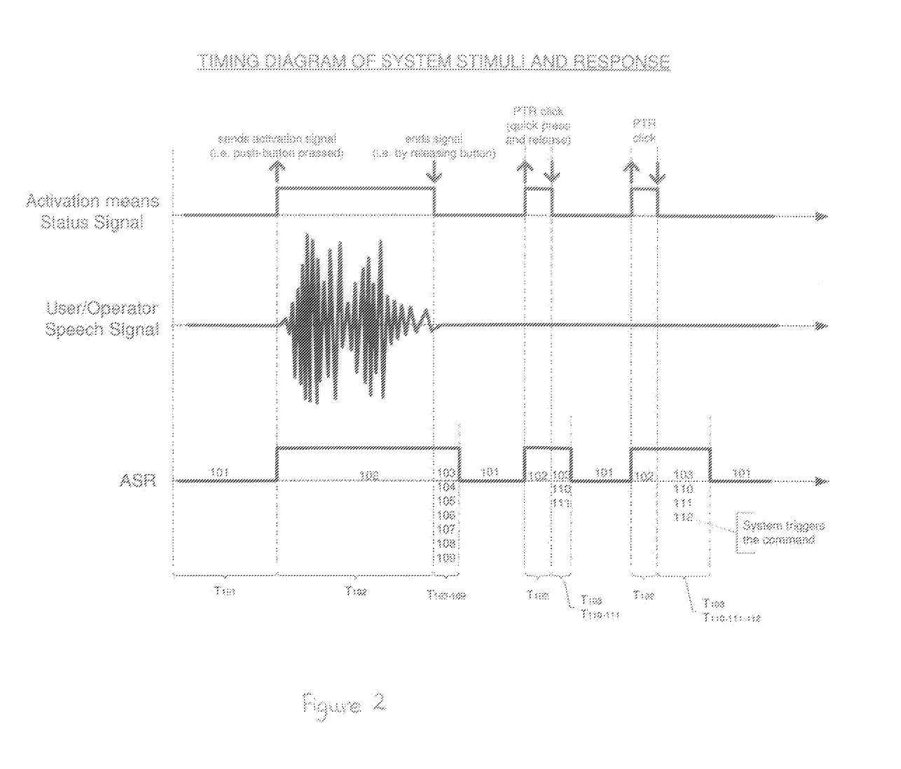

A process flow diagram depicting the main process steps, is depicted in FIG. 1, in which reference numerals (101-112) signify certain individual steps, decisions, and outcomes. For cross-reference, an illustrative timing diagram (FIG. 2) describes in additional detail the system stimuli, and responses, and their chronological sequence.

Reference is now made primarily to FIG. 1 and can be followed in sequence on FIG. 2. Initially, the confirmation system awaits a signal from an activation means, such as a push-button or Press-to-Recognize (PTR) means 101. When the confirmation system detects the activation means, the system starts the ASR, which attempts recognition of an utterance signal that follows the activation means signal (102). When the confirmation system detects the release of the activation means (e.g. button—deactivation or termination), it stops the speech recognition processing. If the time between for example push-button press and release (the duration of the utterance, 103) is under a maximum length allowed for one click (e.g., 500 ms), the utterance is considered as one single click (where two clicks makes a double click and so on) as long as the confirmation timer (107), reset when the recognized utterance is stored, has not expired (103).

If the duration of the utterance is longer than the maximum length allowed for one click or if the timer has expired (e.g., set at 10 seconds—the interval within which confirmation is returned by the user to the ASR), the confirmation system retrieves all recognition result parameters (104) from the ASR. In some embodiments of the invention, the result parameters (104) may include the recognition of the string and a confidence level.

If the ASR is unable to match the utterance with an entry in a stored library of commands (e.g. “heading 999 degrees”) or if the confidence is under the rejection threshold (105), in some embodiments, the system returns to its initial state, where it will wait for another utterance (101).

If the ASR successfully matches the speech command to an entry in the stored library of commands (e.g. “heading 099 degrees”), the phonemes that comprise the utterance are considered as recognized. At block (106), the system stores the recognition result parameters. In some embodiments, the recognition result parameters may include the result string, the confidence level, and the semantic or meaning of the command signal from the user.

In an embodiment of the invention, a confidence level is expressed by a score assigned by the ASR, which in most applications is rarely 100%. In general, the basic concepts of speech recognition engine are known. The signal that is received by the ASR is converted to possible phonemes, which are matched to the supported grammar and vocabulary and a corresponding score or confidence level is derived.

For example, the ASR might receive a signal such as “heading 999.” But the supported grammar lacks any such heading, since 360 degrees may be the highest value stored. In such an example, the ASR may return to the user with a signal that may represent “heading 199 degrees?” after assigning a low confidence level to the initial signal sent by the user. Alternatively, the ASR may be programmed to reject the initial command and ask for it to be repeated.

In general, it can be stated that a confidence threshold is empirically set, depending on such factors as the complexity of the vocabulary, for example. Often, a lower threshold, for example 30%, may be assigned where the language falls in a complex environment. For normal speech in a relaxed terminology, a normal confidence threshold may be 30-50%. In other environments, for example, where there single words are used with simple grammar, and the phraseology is strict, a confidence level of 50-60% may be appropriate. In general, several aspects of the disclosed invention can be customized: but many have a common purpose, and that is the desire to avoid making a big mistake.

A timer and the PTR-click counter (107) may in some aspects of the invention be reset at this point to give the user a limited period of time (e.g., 10 seconds) to confirm the recognition results with for example a predetermined number of clicks. Preferably, at or close to the same moment, the result is displayed or played back to the user (108) and in some embodiments a tone is played to the user (109). The recognition result might be displayed to the user, like “heading 320?”, with methods such as those described in U.S. Pat. No. 5,864,815, entitled “METHOD AND SYSTEM FOR DISPLAYING SPEECH RECOGNITION STATUS INFORMATION IN A VISUAL NOTIFICATION AREA” or in U.S. Pat. No. 5,819,225, entitled “DISPLAY INDICATIONS OF SPEECH PROCESSING STATES IN SPEECH RECOGNITION SYSTEM.” The '815 and '225 patents are incorporated here by reference. The recognition result might also be played back using text-to-speech (TTS) or a voice-concatenated response, for example, “confirm heading 3 2 0”.

If a tone is played to the user (109), it can be generally characterized with high prosody and more precisely with raising intonation, suggesting a request to the user for confirmation. It will be appreciated that one example of the term “played to the user” is but one specie of a more generic set of signals that can be sent to the user. Other examples include other aural tones, a visual signal of some kind, or, if desired, a tactile signal.

After this sequence of process steps, the system returns to wait for utterance (101) or an activation signal. Two—among other—outcomes are possible: (1) the user will perceive and notice an error in the recognition result and therefore repeat his command; or (2) the user presses and releases the push-button—preferably before the confirmation timer expires.

In cases where the user confirms the result with multiple clicks (for instance, a double-click), the confirmation system starts the ASR on each push-button press (102), but quickly stops the speech recognition on button release. If the utterance is under the maximum length (e.g., 500 ms) allowed for one click (103) and the time for confirmation is not expired, the confirmation system increments the push-button counter (or PTR-click count, 110) and evaluates the number of consecutive push-button clicks (111). If a single click, the system simply returns to wait for the utterance (101). If the number of push-button clicks reaches the threshold for confirmation (111)—for instance, a threshold fixed at two for a double-click confirmation—the command previously saved (106) is triggered (112).

In all cases, if the confirmation timer expires during this process, the saved utterance (106) is rejected or becomes invalid. The user must then repeat the command to receive a new request for confirmation.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. In steps executed by a user, an automated command or speech recognition (ASR) apparatus and a system controlled by the ASR, the steps including:

| | | | Controlled |
|---|---|---|---|
| Step | User | ASR | System |
| | Command | | |
| 1 | ---------→ | | |
| | (Command signal) | | |
| | Recognition | | |
| 2 | ←----------- | | |
| | (Recognized command | | |
| | signal) | | |
| | Validation | | |
| 3 | ---------→ | | |
| | (Confirmed recognized | | |
| | command signal) | | |
| | | Execution | |
| 4 | | ---------→ | |
| | | (ASR command signal), | |

a method of processing in the ASR a command signal transmitted by a user (step 1), the ASR identifying the command signal using a command recognition technique and remitting to the user (step 2) a recognized command signal indicative of a recognition result, the user then transmitting to the ASR (step 3) a confirmation signal that communicates confirmation by the user of the recognition result, the ASR then sending to the controlled system an ASR command signal (step 4), the method further comprising the steps of:
(A) identifying in the ASR a signal from an activation means for activating the ASR that precedes the user-issued command signal;
(B) upon identifying the signal from the activation means, starting a timer to define a predetermined time-out period and issuing a user-perceptible signal that the ASR is awaiting receipt of the user-issued command signal;
(C) retrieving from a storage medium associated with the ASR a command set to be compared with the user-issued command signal; and
(D) monitoring, in the ASR during the time-out period, one or more user-issued command signals and comparing them with commands in the command set, and
(i) where one of the user-issued command signals matches one command in the command set during the time-out period, sending from the ASR to the user the recognized command signal and awaiting the confirmed recognized command signal from the user before sending one ASR command signal to the controlled system;
(ii) where none of the user-issued command signals match any command in the command set during the time-out period, resetting the ASR at the end of the time-out period to await receipt and identification by the ASR of a subsequent user-issued command signal.

2. The method of claim 1 wherein step (A) comprises identifying a signal from an activation means selected from the group consisting of a push-button, a spoken command, a push-to-talk signal, a signal emitted by a keypad, a button, a foot pedal, an on/off switch, a vasculating switch, eye movement, a tactile means for generating a signal, and combinations thereof.

3. The method of claim 1 wherein step (A) further comprises identifying in the ASR a signal from an activation means that precedes a user-issued command signal, the user-issued command signal being selected from the group consisting of a voice message, a visual signal, an aural signal, and combinations thereof.

4. The method of claim 1 wherein step (B) comprises starting a timer upon identifying the signal from the activation means to initiate a predetermined time-out period.

5. The method of claim 1 wherein step (B) further comprises issuing a user-perceptible signal from the ASR signifying that the ASR is awaiting receipt of the user-issued command signal, the user-perceptible signal being selected from the group consisting of an aural signal, a visual signal, a tactile signal, and combinations thereof.

6. The method of claim 1 wherein step (D)(i) comprises sending from the ASR to the user a recognized command signal, the recognized command signal being selected from the group consisting of a visual signal, an aural signal, a tactile signal, and combinations thereof.

7. The method of claim 1 wherein step (D)(i) comprises initiating a timer to define the time-out period after the recognition result is produced by the ASR before communicating the result to the user.

8. The method of claim 7 further comprising the step of playing a tone to the user to signify that a recognition result requires confirmation by the user.

9. The method of claim 8 further comprising the steps of the user pressing and releasing a push-button means a predetermined number of times to signify to the ASR that the recognition result was correct.

10. The method of claim 9 wherein the predetermined number of times equals two.

11. The method of claim 10 wherein the ASR upon receiving the user's confirmation checks the elapsed time following communication to the user of the recognition result and if validation by the user is communicated to the ASR within the predetermined period of time, the ASR triggers an appropriate command to the controlled system.

12. The method of claim 11 wherein if the predetermined period expires, a saved user-initiated command is rejected and invalidated, thereby requiring the user to repeat the command to receive a new request for confirmation.

13. The method of claim 1 further including an initial step of selecting a user from the group consisting of an operator, a pilot, a driver, a robot, an automaton having artificial intelligence, and combinations thereof.

14. The method of claim 1 further comprising an initial step of locating a platform with which the user, ASR, or control system is in communication, the platform being selected from the group consisting of a vehicle, an aircraft, a drone, a marine operator, a lunar excursion module, a planetary excursion module, and combinations thereof.

15. The method of claim 1 further comprising an initial step of placing the user in an air-based aeronautical environment in which the command signal given by the user to the ASR is selected from the group consisting of a heading control command, an altitude change command, a rate of change of altitude command, a flap deployment command, a power setting command, a landing gear deployment command, an aircraft illumination command, a spoiler deployment command, a navigation system command, an aircraft internal environmental command indicative of temperature, humidity, or temperature and humidity, an aircraft electrical system command, an aircraft navigation system command, and combinations thereof.

16. The method of claim 1(D) further comprising the step of generating recognition result parameters, the parameters being selected from the group consisting of a result string, a confidence level, and meaning of the command signal from the user.

17. The method of claim 1 further comprising the step of providing the same activation means used to precede an initial command signal from the user to the ASR as is deployed by the user to remit to the ASR the confirmed recognized command signal.

18. A command confirmation system including an automated command recognition (ASR) apparatus and a system controlled by the ASR, the system operating in an environment having:

| | | | Controlled |
|---|---|---|---|
| Step | User | ASR | System |
| | Command | | |
| 1 | ---------→ | | |
| | (Command signal) | | |
| | Recognition | | |
| 2 | ←----------- | | |
| | (Recognized command | | |
| | signal) | | |
| | Validation | | |
| 3 | ---------→ | | |
| | (Confirmed recognized | | |
| | command signal) | | |
| | | Execution | |
| 4 | | ---------→ | |
| | | (ASR command signal), | |

the system comprising:
means for processing in the ASR a command signal transmitted by a user (step 1), the ASR identifying the command signal using a command recognition technique and remitting to the user (step 2) a recognized command signal indicative of a recognition result, the user then transmitting to the ASR (step 3) a confirmation signal that communicates confirmation by the user of the recognition result, the ASR then sending to the controlled system an ASR command signal (step 4), the system further comprising:
(A) means for identifying in the ASR a signal from an activation means for activating the ASR that precedes the user-issued command signal;
(B) means for timing to define a predetermined time-out period and issuing a user-perceptible signal that the ASR is awaiting receipt of the user-issued command signal;
(C) means for retrieving from a storage medium associated with the ASR a command set to be compared with the user-issued command signal; and
(D) means for monitoring, in the ASR during the time-out period, one or more user-issued command signals and comparing them with commands in the command set, and
(i) where one of the user-issued command signals matches one command in the command set during the time-out period, means for sending from the ASR to the user the recognized command signal and awaiting the confirmed recognized command signal from the user before sending one ASR command signal to the controlled system;
(ii) where none of the user-issued command signals match any command in the command set during the time-out period, means for resetting the ASR at the end of the time-out period to await receipt and identification by the ASR of a subsequent user-issued command signal.

19. The system of claim 18 wherein the activation means comprises one or more members of the group consisting of a push-button, a spoken command, a push-to-talk signal, a signal emitted by a keypad, a button, a foot pedal, an off/off switch, a vasculating switch, eye movement, a tactile means for generating a signal, and combinations thereof.

20. The system of claim 18 wherein the one or more user-issued command signals are transmitted in a medium selected from the group consisting of a voice message, a visual signal, an aural signal, and combinations thereof.
